(19) United States
(12) Patent Application Publication
(10) Pub. No.: US 2003/0059191 A1
(43) Pub. Date: Mar. 27, 2003

(54) Fiber coupler twister

(75) Inventors: Cho-Liang Liang, Hsin-Tien City (TW); Ming-Tsai Wang, Hsin-Tien City (TW)

Correspondence Address: BACON & THOMAS, PLLC, 625 SLATERS LANE, FOURTH FLOOR, ALEXANDRIA, VA, 22314

(73) Assignee: Ahoku Electronic Company, Taipei (TW)

(21) Appl. No.: 09/956,885

(22) Filed: Sep. 21, 2001

(51) Int. Cl. G02B 6/00; G02B 6/26

(52) U.S. Cl. 385/134; 385/43

(57) ABSTRACT

The present invention provides a fiber coupler twister used in fused taper process, in which two round plates having a plurality of holes thereon are each placed in the troughs of two pedestals respectively, and can be rotated. When manufacturing a fiber coupler, a plurality of fibers are each passing through the plurality of holes on the two round plates respectively, and then rotate the two round plates, so as to form various fiber couplers with different twisting angles.

### FIELD OF THE INVENTION

The present invention relates to a fiber coupler twister, and more particularly to a round plate used in fused taper process for fiber coupler.

### BACKGROUND OF THE INVENTION

A conventional manufacturing process for fiber coupler is stated as follows:

1. As shown in FIG. 1, two parallel fibers F1, F2 are disposed in the grooves F3 of a vacuum or a mechanical fixture.

2. Both fibers F1, F2 are twisted manually and then fixed on the fixture again, as shown in FIG. 2.

3. The twisted areas (node) of the fibers F1, F2 are fused together with a high temperature flame so as to form the fiber coupler as required.

The above method has some disadvantages as below:

1. Since the twisting operation is done by hand, the twisted area of the two fibers F1, F2 will not exactly locate on the middle position each time, and should be adjusted by operator.

2. When the fibers F1, F2 are twisted, the fibers have to be placed in the grooves F3, so the minimum twisting angle is 180°, an angle below 180°, such as 90°, can not be achieved.

3. Since the twisting and holding operation is done by hand, the tension in the fiber to be fused cannot not be accurately controlled, and so does the yield.

4. The operation cannot twist 3 fibers or more simultaneously.

### OBJECT OF THE INVENTION

It is therefore an object of the present invention to provide a fiber coupler twister, which comprises two same round plates having a plurality of holes thereon, and being each placed in the troughs of two pedestals respectively, and can be rotated. The holes on the two round plates are each correspondingly located at the same place. A plurality of fibers are each passing through the corresponding holes on the two same round plates and are pulled straightly, and then rotate the two round plates respectively in the opposite directions, a fiber coupler having required twisting angles can be accomplished.

### BRIEF DESCRIPTION OF THE DRAWINGS

FIG. 1 shows schematically the conventional preparing of fibers for manufacturing fiber coupler.

FIG. 2 shows schematically the conventional twisting of fibers for manufacturing fiber coupler.

FIG. 3 shows schematically the fiber coupler twister according to the present invention.

FIG. 4 shows schematically that two fibers passes respectively through the holes on the fiber coupler twister.

FIG. 5 shows schematically how the fibers are twisted.

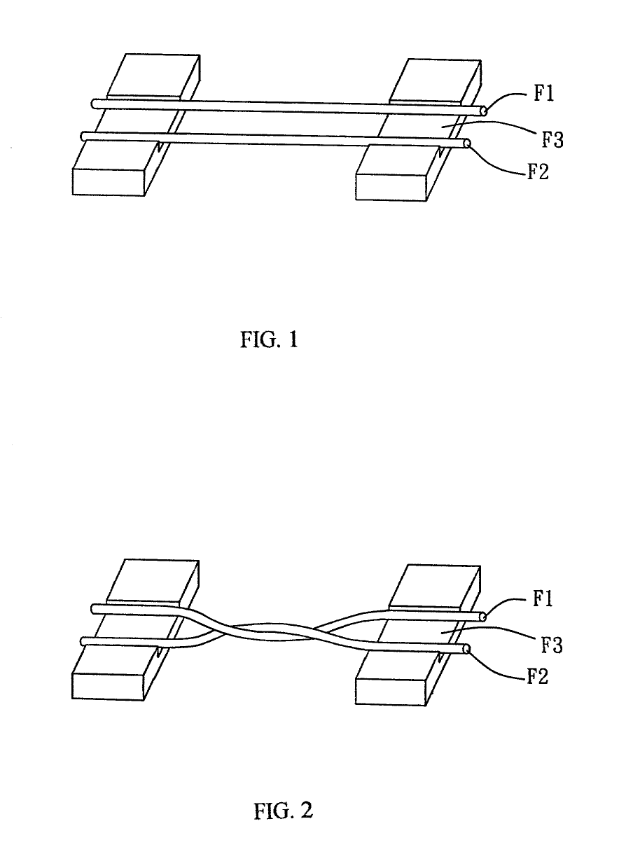

### DETAILED DESCRIPTION OF THE INVENTION

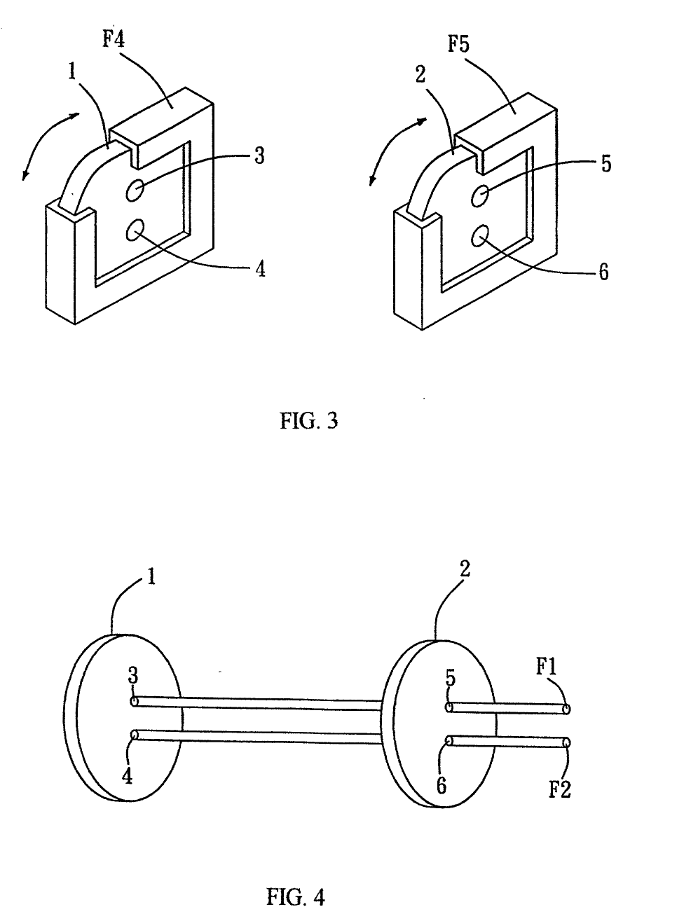

Referring to FIG. 3, which shows schematically the fiber coupler twister according to the present invention. Round plates 1 and 2 are each placed in the troughs of two pedestals F4 and F5 respectively, and can be rotated.

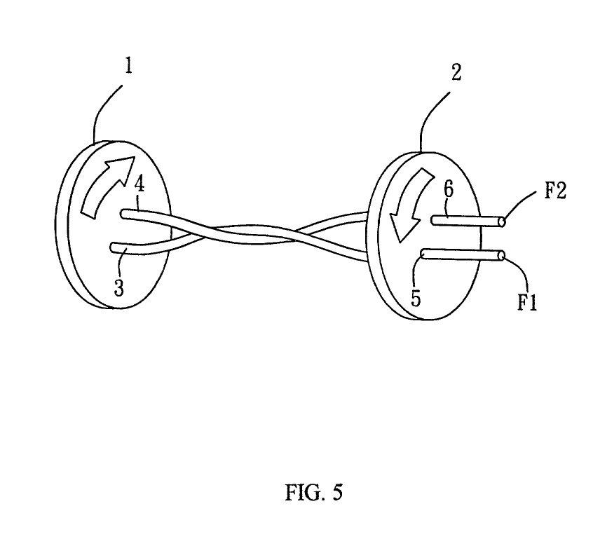

Referring to FIG. 4, a plurality of holes 3, 4, 5, 6 are punched on the round plates 1 and 2 respectively, and fiber F1 passes through holes 3 and 5, while fiber F2 passes through holes 4 and 6. Next, pulling the fibers straightly and fixing the fibers by holding fixture, then rotating the two round plates 1, 2 in the opposite directions, a fiber coupler having required twisting angle can be accomplished, as shown in FIG. 5.

The advantages of the present invention are as below:

1. Since the corresponding holes on the two round plates are located at the same place, the twisted area of the fibers will be located at the middle position automatically.

2. Since two round plates are used for twisting, any required twisting angle for fiber coupler can be accomplished.

3. Three holes or more can be punched on the round plates, so three fibers or more can be twisted simultaneously.

The spirit and scope of the present invention depends only upon the following claims, and is not limited by the above embodiment.

What is claimed is:

1. A fiber coupler twister, comprising two same round plates having a plurality of holes theron, said two round plates being placed respectively in the troughs of two pedestals, and can be rotated, corresponding holes on the two round plates being located at the same place, a plurality of fibers being passed respectively through the corresponding holes on the two round plates, and then being pulled straightly and being fixed, by rotating the two round plates in the opposite directions, any required twisting angles for fiber coupler twister can be accomplished.

2. A fiber coupler twister according to claim 1, wherein the number of the plurality of holes on each round plate is at least two, and can be three or more.

3. A fiber coupler twister according to claim 1, wherin only one of the round plates is rotated to twist the fibers.
